(19) United States
(12) Patent Application Publication
(10) Pub. No.: US 2015/0085508 A1
(43) Pub. Date: Mar. 26, 2015

(54) System for Illuminating a Bicycle

(71) Applicant: Keaton McConathy, Angleton, TX (US)

(72) Inventor: Keaton McConathy, Angleton, TX (US)

(21) Appl. No.: 14/036,438

(22) Filed: Sep. 25, 2013

(51) Int. Cl. B62J 6/00

(52) U.S. Cl. CPC B62J 6/003
USPC 362/473

(57) ABSTRACT

A system for illuminating a bicycle is described herein. In one embodiment the bicycle frame illuminator can comprise a plurality of LED lights, one or more holders, one or more connectors, and a battery. Each of the holders can comprise the plurality of LED lights. Moreover, each of the connectors connectable to each of the holders. Furthermore, the battery that electrically connects the holders and the connectors.

### BACKGROUND

This disclosure relates to a system for illuminating a bicycle.

For years, bicycles are being used not only as a form of recreation but also as a means of transportation. Many bicycle collisions with vehicles occur during dusk or at night due to poor visibility. It is for this reason that safety precautions such as helmets, lights, and reflectors are continuously being developed to improve safety of the riders. Methods for illuminating bikes have evolved over the years. Reflectors are one of the commonly used devices, which can allow cyclist to be seen by other motorists. However, reflectors can be inadequate as they do not provide enough light for a motorist to see the bicyclist clearly from all directions. Another commonly used device involves the use of flashing halogen lights, which are usually attached at the front and rear of a bike. However such method can usually distract or dazzle oncoming motorists, resulting in accidents.

As such, it would be useful to have a system for illuminating a bicycle.

### SUMMARY

A system for illuminating a bicycle is described herein. In one embodiment the bicycle frame illuminator can comprise a plurality of LED lights, one or more holders, one or more connectors, and a battery. Each of the holders can comprise the plurality of LED lights. Moreover, each of the connectors connectable to each of the holders. Furthermore, the battery that electrically connects the holders and the connectors.

### BRIEF DESCRIPTION OF THE DRAWINGS

FIG. 1A illustrates an exploded view of a LED light strip and a two-pin connector.

FIG. 1B illustrates another embodiment of LED light strip and a four-pin connector 106.

FIG. 2 illustrates an embodiment of a LED light system that uses a two-pin connector.

FIG. 3A illustrates another embodiment of a LED light system that uses a four-pin connector.

FIG. 3B illustrates an exploded view of a remote control comprising an ON and/or OFF button, a brightness control button, a color control button, and a mode control button.

FIG. 4 illustrates a LED light system installed to a bicycle.

FIG. 5A illustrates an exploded view of a LED light strips comprising a strapping mechanism and an adhesive.

FIG. 5B illustrates how a LED light strips can be attached to a frame.

FIG. 6A illustrates an embodiment of a LED light strips housed in a tubular casing.

FIG. 6B illustrates how a tubular casing can be attached to a frame.

### DETAILED DESCRIPTION

Described herein is a system for illuminating a bicycle. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

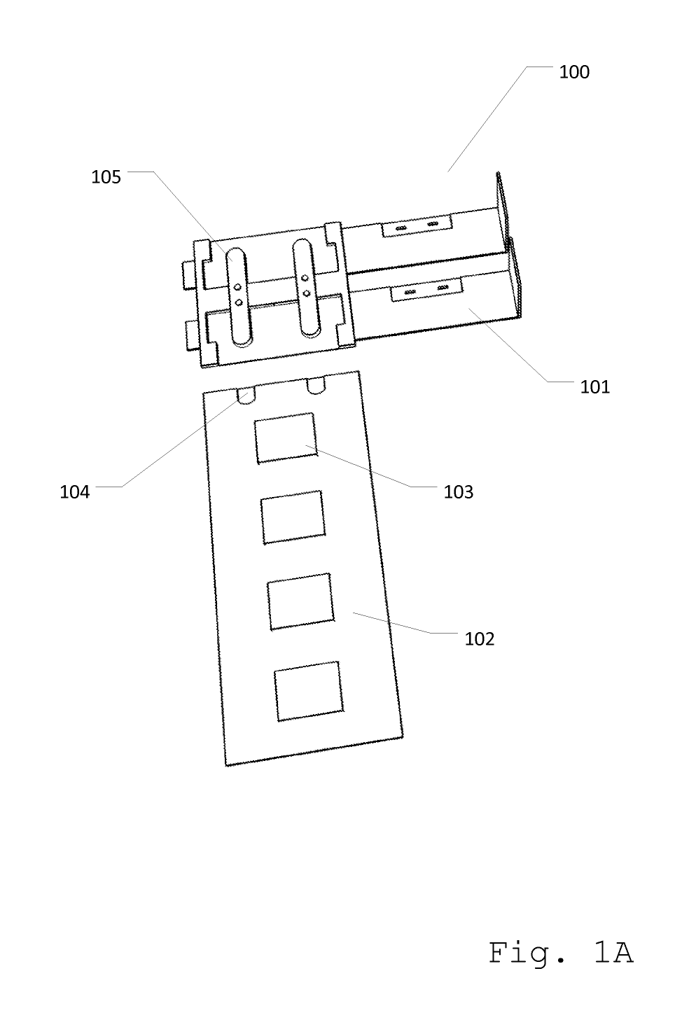

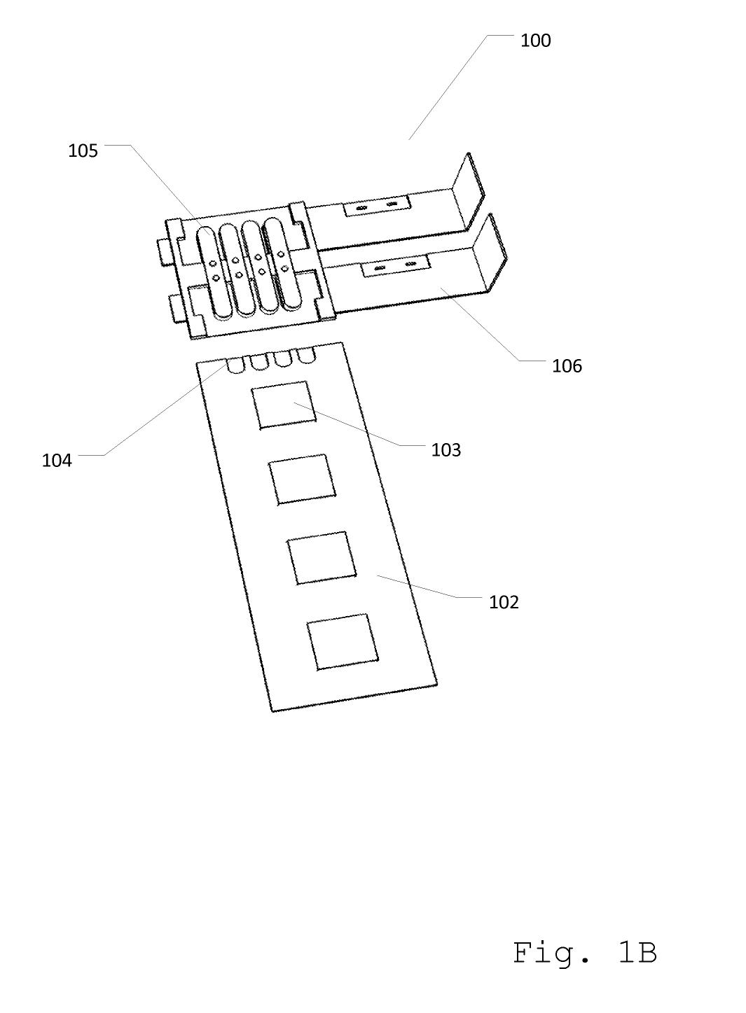

FIG. 1A illustrates an exploded view of a LED light strip 100 and a two-pin connector 101. LED light strip 100 can comprise of a tape 102, a plurality of LED lights 103, and a female plug 104. LED light strips 100 can be any type of light-emitting diode such as miniature, mid-range, high-power, and/or application-specific variations. LED light strips 100 can vary in sizes, shapes, and/or color. Tape 102 can be a long and thin strip material made of plastic, fabric, and/or metal. Tape 102 can be used to enclose and hold one or more LED light 103 together. Moreover, tape 102 can be made of waterproof material to protect LED light 103 from water and/or moisture. Female plug 104, as illustrated in this figure, comprises of two holes which can be mateable with two-pin connector 101. Two-pin connector 101 can comprise a plurality of metal pins 105 which can be compatible with female plugs 104. Two-pin connector 101 can be a type of an electrical connector that can be used to connect one or more electrical circuits together, either temporarily or permanently.

FIG. 1B illustrates another embodiment of LED light strip 100 and a four-pin connector 106. In this embodiment, female plug 104 can comprise of four holes that can be mateable with four-pin connector 106. Four-pin connector 106 can comprise of metal pins 105 which can be compatible with female plugs 104. Four-pin connector 106 can be a type of an electrical connector that can be used to connect one or more electrical circuits together, either temporarily or permanently.

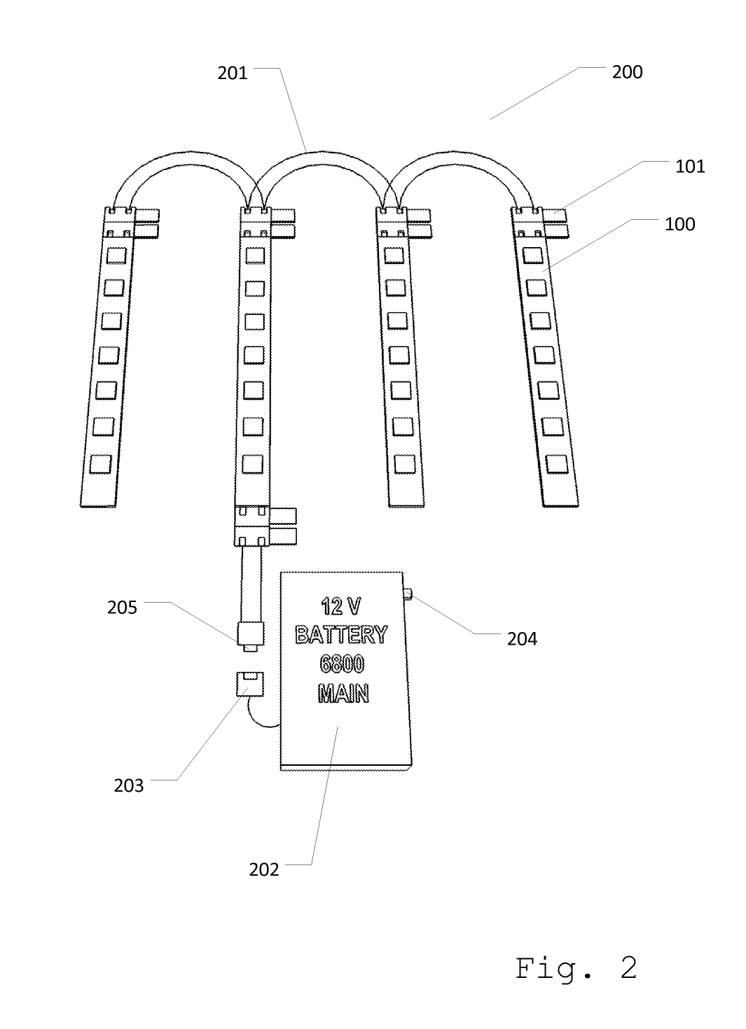

FIG. 2 illustrates an embodiment of a LED light system 200 that uses two-pin connectors 101. In such embodiment, LED light system 200 can comprise LED light strips 100, a plurality of wires 201, a battery 202, and a switch 204. LED light system 200 can be a mechanism used to illuminate any land transportation vehicles or mobile devices that can include but are not limited to bicycles, scooters, and motor bikes. Wires 201 can comprise any insulated or non-insulated conductors designed to bear electrical loads and carry electrical signals. Wires 201 can be used to connect one or more LED light strips 100 with battery plug-in 203. As such, each two-pin connector 101 can be connected to both ends of LED light strips 100. The two-pin connector 101 can be used to either connect another set of LED light strips 100 together or to connect one set of LED light strips 100 to battery 202. A two-pin male plug 205 can be used to connect LED light strips 100 to battery plugin 203. One or more LED light strips 100 connected through two-pin connector 101 can allow LED light strips 100 to produce solid LED-light color.

Battery 202 can be electrochemical cells capable of converting energy into an electrical energy. Battery 202 can vary in shapes, sizes, and can be made of waterproof coating material capable of resisting ingress of water. In one embodiment, battery 202 can be rechargeable. As such, battery 202 can comprise a battery plug-in 203. Battery plug-in 203 can be any form of device or system capable of charging battery 202. In another embodiment, battery 202 can be removable and replaceable. Switch 204 can be connected to battery plug-in 202. In one embodiment, switch 204 can be used to turn on and/or of LED light strips 100. In another embodiment, switch 204 can be used to regulate the light emitted from LED light strips 100. As such, the current supplied to LED light strips 100 can be regulated thus, controlling the brightness of light produced from LED light strips 100.

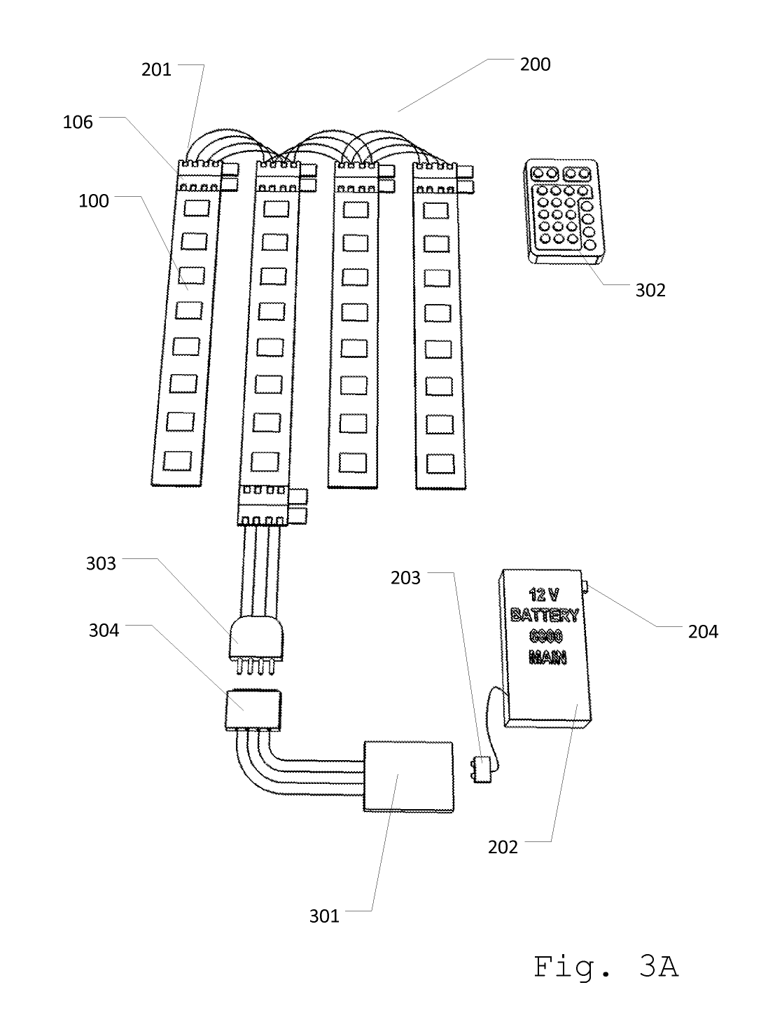

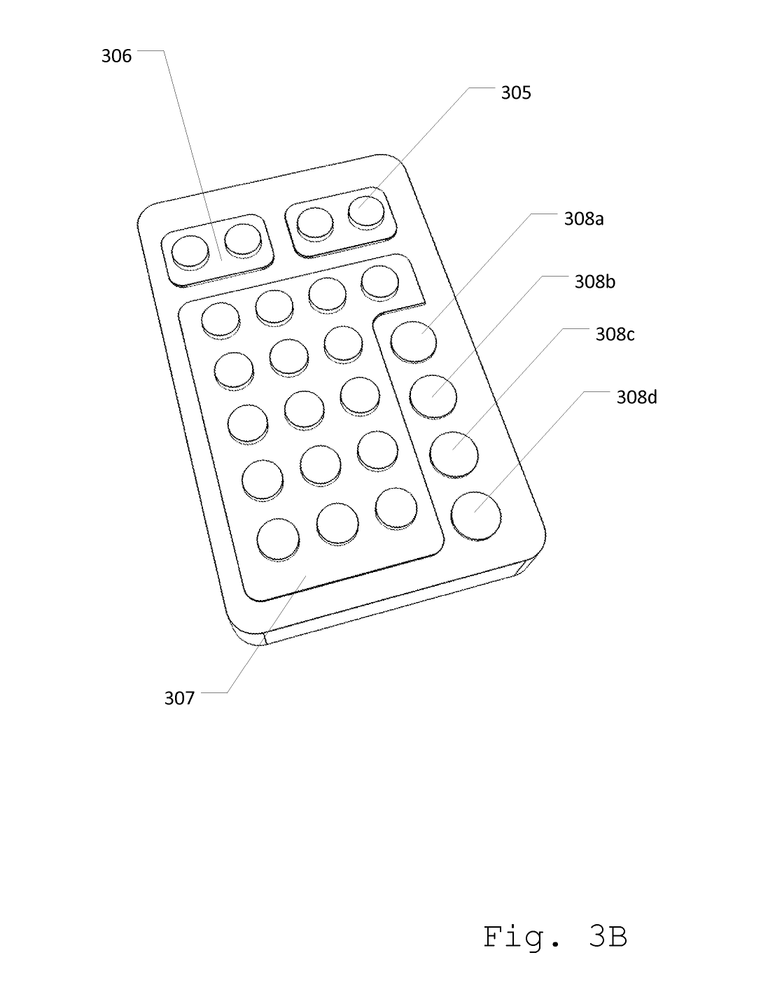

FIG. 3A illustrates another embodiment of an LED light system 200 that uses four-pin connectors 106. In such embodiment, LED light system 200 can further comprise a control box 301 and a remote control 302. Control box 301 can be a device that directs the operation of LED light system 200. Remote Control 302 can be a component of LED light system 200 that enables a user to wirelessly control the operation of LED lights 103. In another \embodiment, control box 301 can also comprise of buttons that can be used to control LED light system 200.

LED light strips 100 can be connected through wires 201. Four-pin connectors 106 can be attached on both ends of LED light strips 100. As such, wires 201 can be attached on four-pin connectors 106, which connect one or more LED strips 100 together. A four-pin male plug 303 can be used to connect to a four-pin female plug 304 of control box 301. Battery 202 can be connected to a control box 301 that can supply the required electric current of LED light system 200.

FIG. 3B illustrates an exploded view of remote control 302 comprising an ON and/or OFF button 305, a brightness control button 306, a color control button 307, and a mode control button 308. ON and/or OFF button can be used to turn LED light system ON and/or OFF. Brightness control button 306 can comprise of two or more level of brightness of light. As such, a user can choose to set LED light strips 100 from dim to brightest. Color control button 307 can comprise of one or more colors. The colors LED light switch system 200 can project can vary from shades of red, green, blue, white, and/or combination of the said colors. Furthermore, color control button 307 can enable a user to choose a specific color that LED light strips 100 projects. The key buttons of color control buttons 307 can acquire the same color it can project on LED lights 103. Mode control button 308 can comprise of four modes a flash mode 308a, a strobe mode 308b, a fade mode 308c, and a smooth mode 308d. Flash mode 308a can produce a sudden or intermittent burst of light. Flash mode can be used to quickly illuminate a dark area. Strobe mode 308b can create pulses of light at controllable duration rates. Strobe mode 308b can be used to emit series of short or instant lighting to freeze a series of motions. Fade mode 308c can project light that gradually dims or dies out gradually. Smooth mode 309d can produce a standard solid illumination of light.

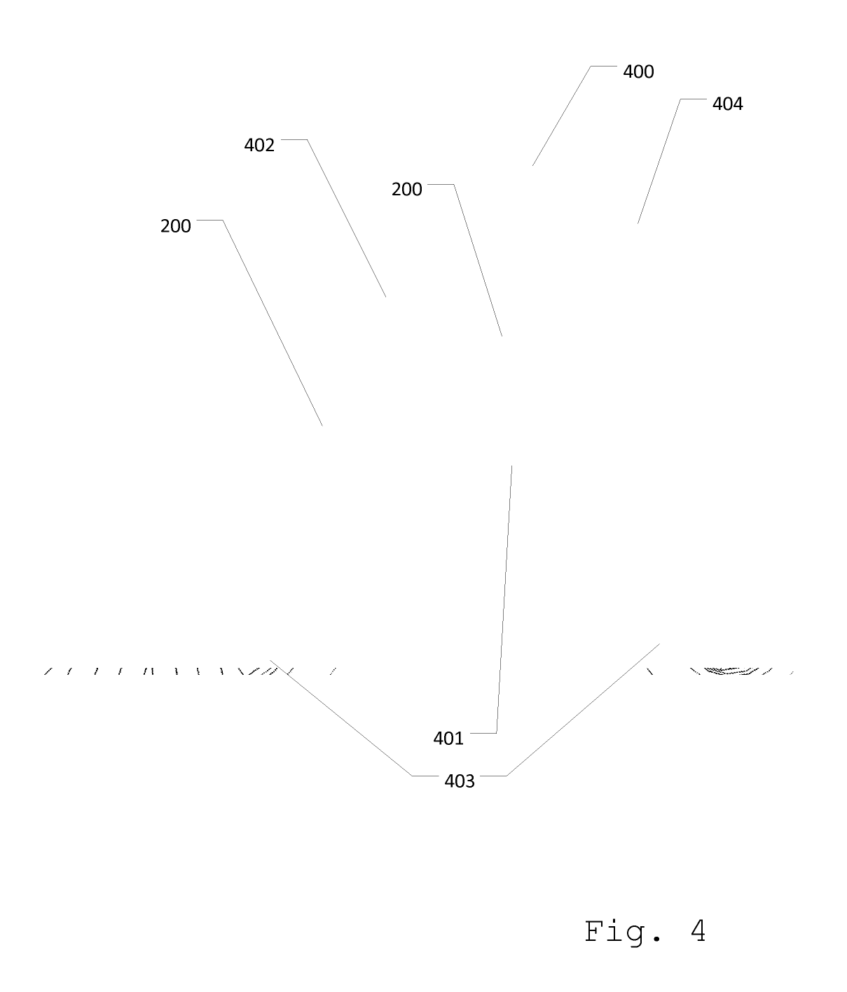

FIG. 4 illustrates LED light system 200 installed to a bicycle 400. Frame 401 is typically the largest portion of bicycle 400. Frame 401 can be the main component of bicycle 400 wherein seat 402 and wheels 403 are attached. Seat 402 can be the portion of bicycle 400 that a user can occupy or sat on. Wheels 403 can be the mechanism that allows bicycle 400 to move from one place to another. Handle 404 can be the part of bicycle 400 that a passenger can grip on. Handle 404 can be used maneuver bicycle 400 to any desired direction.

LED light system 200 can be attached to frame 401 through different methods such as adhesion, clamping, strapping, and/or snapping technique. Sets of LED light strips 100 can be connected together through one or more connectors to cover frame 401. Battery 202 can either be permanently or temporarily attached at the bottom of seat 402 and can be connected to one of LED light strips 100 that is closest to battery 202. In an embodiment wherein LED light system 200 can comprise control box 301, control box 301 can also be attached underneath seat 402. In another embodiment, control box 301 can be attached in handle 404. In such embodiment, a user can easily access and/or control the lights illuminating from LED light system 200. Wires 201 can connect two or more LED light strips 100 and battery 202 together to allow continuous flow of electrical current through LED light system 200.

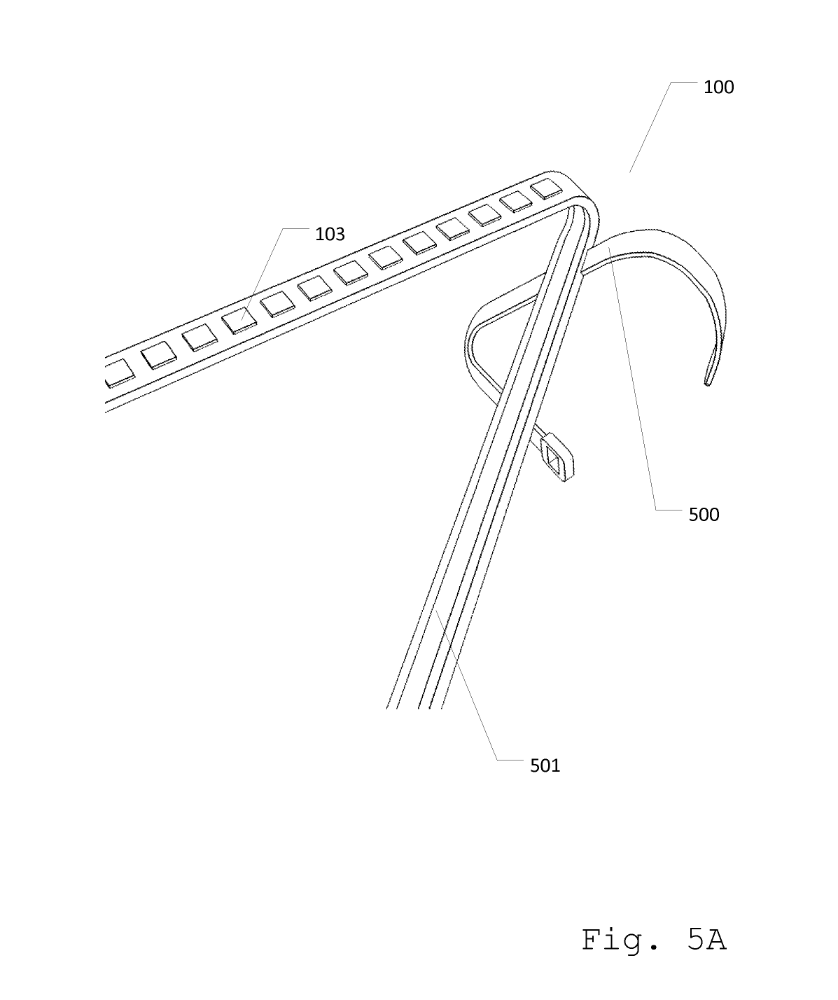

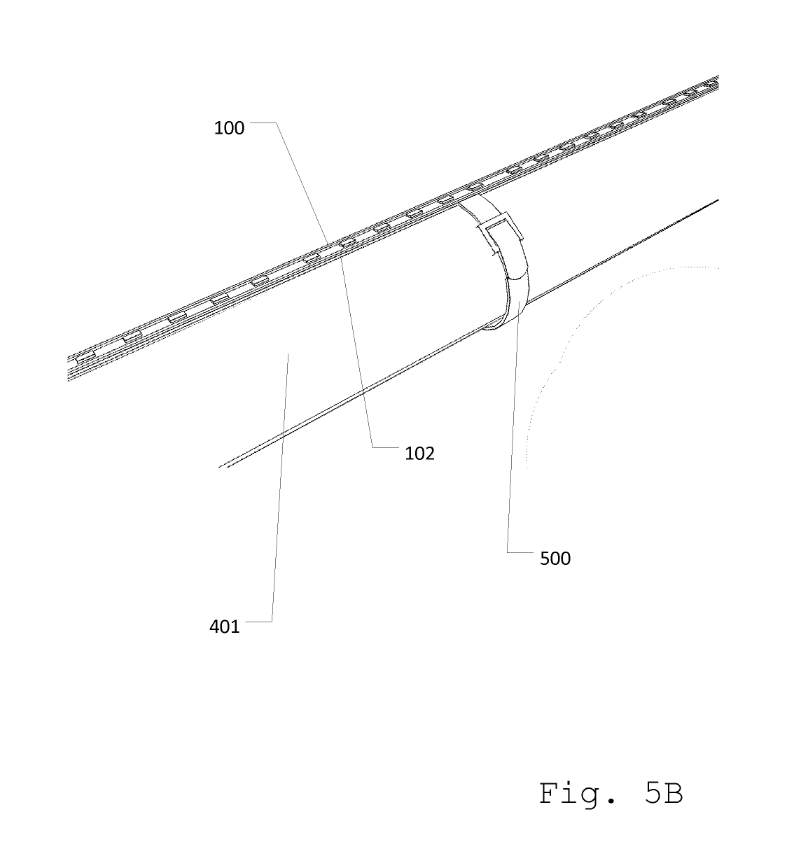

FIG. 5A illustrates an exploded view of LED light strips 100 comprising a strapping mechanism 500 and an adhesive 501. Strapping mechanism 500 can be made up of long narrow strip of pliant material such as fabrics, leather, rubber, or plastic. Strapping mechanism 500 can comprise of fasteners that includes but are not limited to buttons, hook and eye, and hook-and-loop fastener. Portion of strapping mechanism 500 can be permanently attached to LED light strips 100. Adhesive 501 can be used to either permanently or temporarily bond two or more objects together. As such, adhesive 501 can be used to attach LED light strips 100 to any flat surface.

FIG. 5B illustrates how LED light strips 100 can be attached to frame 401. In one embodiment, bottom surface of tape 102 can comprise adhesive 501 that are capable of adhering into frame 401. In another embodiment, strapping mechanism 500 can be utilized to ensure that LED light strips 100 stays in a fixed position around frame 401. As such, one or more LED light strips 100 can be strapped around frame 401. In such embodiment, LED light strips 100 can be removable from frame 401.

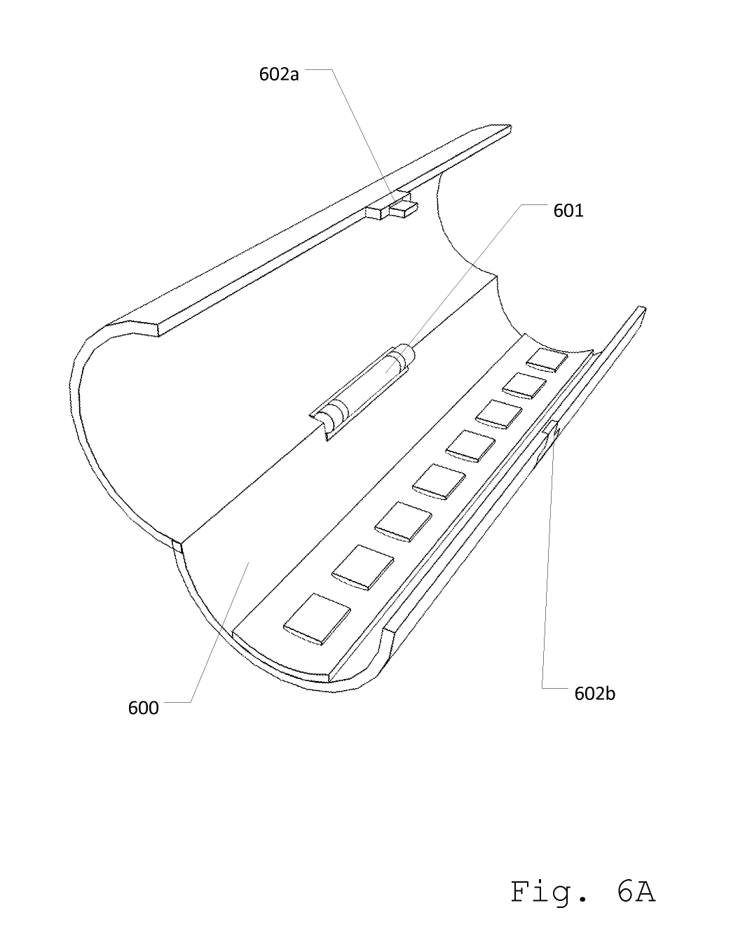

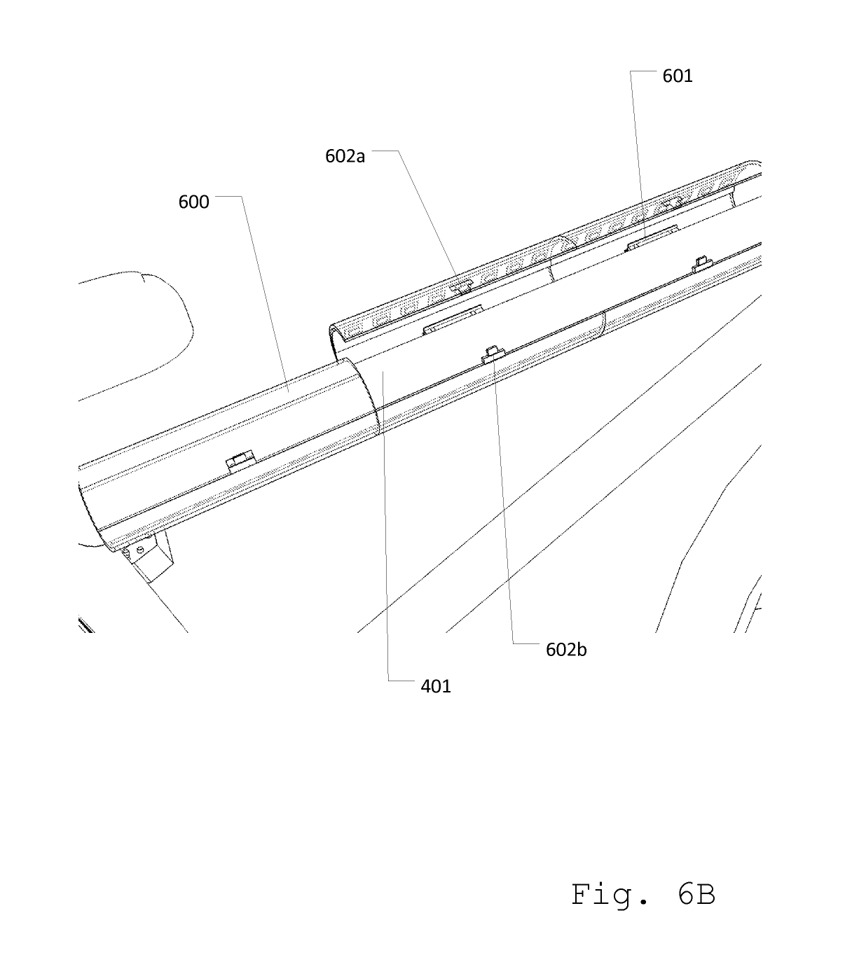

FIG. 6A illustrates an embodiment of LED light strips 100 housed in a tubular casing 600. Tube casing 600 can be a hollow cylinder made of non-corrosive, waterproof, and transparent material such as plastic, rubber, fiber glass, or polymer glass. Tubular casing 600 can comprise a hinge 601, a snap mechanism 602 and LED lights 103. Hinge 601 can be placed at the outer portion of tubular casing 600 while snap mechanism 602 can be positioned at the opposite side of hinge 601. LED lights 103 can be aligned along the inner portion of tubular casing 600. Snap mechanism 602 can be any fastening device that can comprise a pair of interlocking parts, including a socket and a protruding member comprising a catch, where protruding member is linkable to the socket. Further, snap mechanism 602 can comprise a male snap 602a and a female snap 602b. Male snap 602a can be the part of snap mechanism 602 that comprises a protruding part or a snapper. While, female snap 602b can comprise a depression that can securely hold male snap 602a.

FIG. 6B illustrates how tubular casing 600 can be attached to frame 401. Hinge 601 can allow tubular casing 600 to open on the opposite side creating a side opening. As such, the side opening can allow tubular casing 600 be positioned along frame 401. Once properly placed along frame 401, tubular casing 600 can be closed and snap mechanism 602 can hold or lock tubular casing 600 in place. In this embodiment, one or more tubular casings 600 can be large enough to fit and wrapped around tightly along frame 401. Moreover, one or more tubular casings 600 can all be connected together with LED light strips 100.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A bicycle frame illuminator comprising
a plurality of LED lights
one or more holders, each of said holders comprising said plurality of LED lights;
one or more connectors, each of said connectors connectable to each of said holders; and
a battery that electrically connects said holders and said connectors

2. The bicycle frame illuminator of claim 1, further comprising
a control box connects said holder and said battery, further wherein said control box manipulates operation of said LED lights; and
a control

3. The bicycle frame illuminator of claim 2 wherein said battery is rechargeable.

4. The bicycle frame illuminator of claim 2 wherein said control mounts to said control box.

5. The bicycle frame illuminator of claim 2 wherein said control operates said control box wirelessly.

6. The bicycle frame illuminator of claim 1 wherein said holder is a strip.

7. The bicycle frame illuminator of claim 6 wherein said strip comprises an adhesive, further wherein said adhesive attachable to a bicycle frame.

8. The bicycle frame illuminator of claim 6 wherein said strip comprises a strap, further wherein said strap comprises a first fastener and a second fastener, wherein said first fastener mateable said second fastener

9. The bicycle frame illuminator of claim 8 wherein said first fastener and said second fastener are hook and loop fasteners.

10. The bicycle frame illuminator of claim 8 wherein said first fastener and said second fastener are hook and loop fasteners.

11. The bicycle frame illuminator of claim 1 wherein said holder is a tubular casing, said tubular casing comprises
a hinge; and
a snap mechanism, said snap mechanism comprises a male snap and a female snap, further wherein said male snap mateable said female snap.

12. The bicycle frame illuminator of claim 1 wherein said connector comprises a two-pin connector.

13. The bicycle frame illuminator of claim 12 wherein said two-pin connector produces solid LED light color.

14. The bicycle frame illuminator of claim 1 wherein said connector comprises a four-pin connector.

15. The bicycle frame illuminator of claim 14 wherein said four-pin connector produces multiple LED light color.
